(19) United States
(12) Patent Application Publication
(10) Pub. No.: US 2003/0008050 A1
(43) Pub. Date: Jan. 9, 2003

(54) Complete dough shelf stable at room temperature

(76) Inventors: Harry K. Kraklow, Eau Claire, WI (US); Cynthia R. Kandler, Chippewa Falls, WI (US)

Correspondence Address: Tipton L. Randall, 19371 55th Avenue, Chippewa Falls, WI, 54729, US

(21) Appl. No.: 09/946,494

(22) Filed: Sep. 6, 2001

Related U.S. Application Data
(60) Provisional application No. 60/290,396, filed on May 14, 2001.

(51) Int. Cl. A21D 2/00

(52) U.S. Cl. 426/551

(57) ABSTRACT

The invention is directed to a complete cookie dough composition which is shelf stable at room temperature. The dough includes preselected amounts of flour, shortening, emulsifier, eggs, encapsulated leavening, salt, flavoring, a mold inhibitor and a source of sugar in an amount of about 20 to 40 weight percent, including a fluid corn syrup/sugar blend, the sugar effective to provide an A_{w} of less than about 0.75 for the dough product. The dough product has a pH above 7.0 and is stable at ambient temperatures for extended periods without degradation. The dough product produces a baked food product that is acceptable to consumers.

### CROSS-REFERENCE TO RELATED APPLICATIONS, IF ANY

This application claims the benefit under 35 U.S.C. §119 (e) of co-pending provisional application Serial No. 60/290,396, filed May 14, 2001. Application Serial No. 60/290,396 is hereby incorporated by reference.

### STATEMENT REGARDING FEDERALLY SPONSORED RESEARCH OR DEVELOPMENT

Not applicable.

### REFERENCE TO A MICROFICHE APPENDIX, IF ANY

Not applicable.

### BACKGROUND OF THE INVENTION

1. Field of the Invention

The present invention relates to a cookie dough composition and, more particularly, to a shelf stable cookie dough composition which is stable at room temperature for extended periods.

2. Background Information.

Grain based baked products, such as breads, cakes, cookies, etc., have been a food staple for man since biblical times. Some type of finely ground grain is combined with additional ingredients, such as sweeteners, eggs, fats, milk, etc., and the resulting dough is baked to produce a food product with moderate storage stability. Generally, such a dough mixture is freshly prepared from the selected ingredients shortly before baking. The fresh dough has limited stability and is not suitable for storage for even a few days at ambient temperature. Separation of components and microbial growth occur quickly for such fresh dough products.

A recent development in the food industry is the preparation of a dough for a food product, such as bread or cookies, then freezing or refrigerating the dough for storage and later use. Such frozen or refrigerated dough products are widely available to the consumer, but these products often command premium prices. The high cost for these frozen or refrigerated dough products is mainly linked to the cost of freezing and refrigeration during storage and distribution of the frozen dough. These frozen doughs are specially formulated to survive freezing and thawing while still producing a baked food product acceptable to consumers. Some examples of dough or batter compositions for which patents have been granted include the following.

In U.S. Pat. No. 4,910,029, Thulin et al. disclose a shelf-stable cookie having a plurality of textures and visually apparent flavor chips characteristic of freshly baked homemade cookies. The cookie is baked from dough pieces comprising chewy cookie dough or filling enrobed in crispier cookie dough.

Lou et al., in U.S. Pat. No. 4,911,939, describe a cookie dough that is formed into individual cookie pieces and prebaked for a short period of time in order to shape the cookie and provide a gluten-containing skin on the cookie's surface. The prebaked cookie is then packaged for microwave baking at some future time.

In U.S. Pat. No. 5,171,599, Weber discloses a low water activity refrigerated cookie dough composition which includes edible bits containing coloring agents. The dough product is substantially free of color bleed after 90 days of refrigeration. The dough composition has a water activity no greater than about 0.75.

In U.S. Pat. No. 5,223,292, Thulin et al. disclose a cookie having an extended shelf-stable soft texture. The cookies are prepared by coextruding an inner adherent cookie dough bakeable to a soft or chewy texture and an outer non-adherent cookie dough also bakeable to a soft or chewy texture. Kent et al., in U.S. Pat. No. 5,409,720, describe a room temperature shelf stable dough mix that includes a moist ingredient portion and a dry ingredient portion capable of being combined to produce a complete dough requiring no additional ingredients including water or any other moisture. The moist ingredient portion has a water activity level of no greater than 0.85 to provide the desired shelf stability. Both the moist and dry ingredient portions are preferably packaged in substantially air and water impermeable containers of single batch volumes, such that the contents of the packages may be simply mixed together to produce the complete dough without measuring.

In U.S. Pat. No. 6,217,929, Hahn discloses spoonable, low water activity batters. The flour-based batter composition is spoonable at refrigeration temperature and has a refrigerated shelf life of at least about 75 days. The batter has an intermediate water activity of about 0.81 to 0.92. The batters can be baked into products such as muffins, pancakes, waffles, brownies, and other foods that have a high, fluffy texture and a baked height to raw height ratio of greater than about one.

Thus, there is an unmet need for dough products that can be stored at ambient temperatures for extended periods without degradation, and then produce a baked food product that is acceptable to consumers.

### SUMMARY OF THE INVENTION

The invention is directed to a complete cookie dough composition that is shelf stable at room temperature. The dough includes a structure providing amount of flour and a source of sugar in an amount of about 20 to 40 weight percent, including a fluid corn syrup/sugar blend. There is an amount of shortening effective to enhance the organoleptic properties of the dough, and an amount of eggs to provide body to a finished product. An effective amount of emulsifier preventing component separation is present. The dough includes an effective amount of an encapsulated leavening system to provide the finished product a desired density, and an effective amount of a mold inhibiting agent to prevent mold growth therein. The dough has a pH greater than about 7.0, an A_{w} of less than about 0.75, and is shelf stable under room temperature conditions for extended storage.

Tests indicate that an A_{w} no greater than about 0.75 in the complete cookie dough suppresses microbial growth and, therefore, prevents spoilage of the dough composition even at room temperature. The mold inhibiting agent also prevents the growth of mold during storage of the complete cookie dough. The complete cookie dough composition, with the required A_{w} no greater than about 0.75, is shelf stable at room temperature even though the composition includes whole eggs. Tests indicate that the dough composition, according to the present invention, has a shelf life at room temperature of at least 120 days.

### DESCRIPTION OF THE EMBODIMENTS

As noted above, the various prepared bread and cookie dough presently available to consumers are either frozen or require refrigeration temperatures to maintain quality during storage. Applicants have invented a cookie dough composition which does not require refrigeration during storage, and exhibits stability to both separation of components and microbial growth. Also disclosed is a method of preparation of the complete cookie dough composition of the present invention that is shelf stable at room temperature.

The complete dough composition of the present invention that is shelf stable at room temperature has a water activity (Aw) no greater than about 0.75. Tests indicate that the dough composition, according to the present invention, has a shelf life at room temperature of at least 120 days, even with whole eggs included in the dough product. As used in this disclosure, room temperature means a temperature above refrigeration temperature (40° F.) and extending up to about 110° F. As used in this disclosure, water activity or A_{w} may be defined as the ratio of vapor pressure of a solution or mixture to that of pure water at a specific temperature. Thus, A_{w} equals the equilibrium relative humidity. The water activity is a measure of the free or available water in the dough mixture. As is known in the industry, water activity may be measured by measuring the equilibrium vapor pressure of a mixture at a particular temperature and expressing that value as a ratio to the equilibrium water vapor pressure at that temperature.

It is believed that the A_{w} value of the present dough composition is lowered to the 0.75 value by hydrogen bonding between the sugars or other ingredient molecules of the dough and water molecules. The hydrogen bonding ties up the water molecules, preventing free movement of water molecules in the dough composition. Although the mechanism of “binding” the water molecules in the dough system is not precisely understood, this “binding” prevents the growth of microbial organisms in the dough product at room temperature for at least about 120 days. A mold inhibiting agent also prevents the growth of mold during storage of the compete cookie dough.

The cookie dough of the present invention contains a flour component that contributes to the structure of the cookie dough, including the texture, taste and appearance of the final baked product. Useful flours include hard wheat flour, soft wheat flour, barley flour, high amylose flour and low amylose flour. The cookie dough preferably contains about 20-40 weight percent flour, and most preferably about 30-37 weight percent flour.

For purposes of this disclosure and the accompanying claims, “sugar” may include appropriate monosaccharides and disaccharides in either refined or unrefined forms and includes both granulated and powdered sucrose, raw sugar, turbinado sugar, brown sugar, and invert sugar. The sugar incorporated in the dough composition according to the present invention may also include sweeteners such as fructose, dextrose, glycerol, glycerin, maltose, arabinose, sorbitol, maple syrup, corn syrup, molasses, honey, fondant, aspertame, saccharin, acesulfame K, polydextrose, sucralose, alitame and isomalt. The cookie dough preferably contains about 20-40 weight percent sugar, and most preferably, about 25-36 weight percent sugar.

“Shortening” may include any suitable edible fat or fat substitute in either solid or liquid form at room temperature, including vegetable oil, sunflower oil, safflower oil, cottonseed oil, canola oil, soybean oil, olive oil, coconut oil, and palm oil. As used herein, “shortening” may also include fat substitutes including cellulose, gums dextrins, maltodextrins, modified food starch, polydextrose, microparticulated protein, protein blends, emulsifiers, lipid analogs, esterified propoxylated glycerol, and sucrose polyesters. Shortening has beneficial effects on the volume, grain and texture of the baked cookie product, as well as the texture, mouthfeel and other organoleptic properties of the baked good. The cookie dough preferably contains about 10-20 weight percent shortening, and most preferably, about 10-15 weight percent shortening.

“Emulsifier” may include any suitable edible surfactant that increases dough stability and prevents component separation during storage and baking. Emulsifiers can including sodium stearoyl lactylate, sorbitan monostearate, lactylate hydrate, polysorbate 60, polysorbate 80, lecithin, mono- and diglycerides of fatty acids, propylene glycol mono- and diglycerides of fatty acids, glycerol-lacto esters of fatty acids, ethoxylated mono- and diglycerides, and the like. The cookie dough of the present invention most preferably contains about 2-4 weight percent emulsifier. The composition of the cookie dough of the present invention includes sucrose, a fluid corn syrup/sugar blend, shortening, flour, eggs, emulsifier, flavoring, encapsulated sodium bicarbonate, salt, and mold inhibitor. Additional ingredients can include cocoa, chocolate chips/chunks, fruit pieces such as raisins, and candy pieces such as gummy chunks.

In a preferred embodiment of the cookie dough composition, the sucrose includes a mixture of white sugar and brown sugar in a 1.72:1.00 ratio by weight, while the ratio of fluid corn syrup/sugar blend to sucrose is about 1.00:2.50 by weight. In a most preferred embodiment of the cookie dough composition, the fluid corn syrup/sugar blend is a material denoted as CFP Blend 2001, which includes 63% 36DE corn syrup, 8% High Fructose 42, 28% liquid sucrose, and 1 % imitation vanillin. Each of the blend components is known in the industry and commercially available. The 36DE corn syrup typically contains 80% solids and 20% moisture, the High Fructose 42 typically contains 70% solids and 30% moisture, and the liquid sucrose typically contains 68% solids and 32% moisture.

In a preferred embodiment of the cookie dough composition, the shortening includes a mixture of solid and liquid shortening in a ratio of about 3.0:1.0 by weight. Most preferably, the solid shortening is a partially hydrogenated vegetable soybean oil and cottonseed oil material. A suitable solid shortening product is available from Archer Daniels Midland Co., Decater, Ill., and denoted as product code number 101-050. The liquid shortening is most preferably a soybean oil, well known in the food industry and available from numerous suppliers. In a preferred embodiment of the cookie dough composition, the flour includes a mixture of bleached, enriched wheat flour and barley flour in a ratio of about 10.0:1.00 by weight. The eggs utilized for the dough composition are commercially available whole eggs which are preserved. In a preferred embodiment of the cookie dough composition, the eggs are a preserved whole egg product known as Ultraegg^{(R)} widely used in the food industry and available from Cutler Egg Products, Inc., Abbeville, Ala. The preserved egg product, which is as fluid, contains equal amounts of whole eggs and sugar (sucrose) as a preservative, and is guaranteed free of Salmonella, Listeria, Staph and E. Coli. The preserved egg product typically contains 72% solids and 28% moisture. The preserved egg product is stable to microbial and mycotic degradation at room temperature for at least about six months. The preserved egg product is preferably present in the cookie dough at about 8-15 weight percent, and most preferably about 10-14 weight percent. The eggs provide body to the cookie dough both in the unbaked and baked condition.

The emulsifier of the cookie dough of the present invention includes a mixture of lactylate hydrate and lecithin in a ratio of about 3.0:1.0 by weight. Lactylate hydrate is composed of sodium stearol lactylate, ethoxylated mono glycerides, polysorbate 60 and propionic acid. Lactylate hydrate is available from Custom Ingredients, Inc., New Braunfels, Tex. Lecithin is well known in the food industry and available from numerous suppliers, including Archer Daniels Midland Co., Decater Ill.

In a preferred embodiment of the cookie dough composition, the flavoring includes a mixture of clear artificial vanilla flavoring and a butter/vanilla/lemon flavoring in a ratio of about 2.0:1.0 by weight to improve flavor of the cookie dough. The flavoring is present in the cookie dough at about 1.0-1.7 weight percent.

An encapsulated sodium bicarbonate is employed in the preferred embodiment of the cookie dough composition. Sodium bicarbonate encapsulated with a solid shortening is well known in the food industry and commercially available from numerous sources. Encapsulating sodium bicarbonate in a solid shortening prevents reaction of the sodium bicarbonate with water or other dough components during storage at room temperature. Only upon baking the cookie dough does the encapsulated sodium bicarbonate become available to produce leavening of the finished product. The encapsulated sodium bicarbonate is present in the cookie dough at about 0.5-1.5 weight percent and, most preferably, at about 0.9-1.2 weight percent.

The preferred embodiment of the cookie dough composition includes about 0.5% salt by weight to improve taste of the cookie dough, and a mold inhibitor effective in preventing molding of the cookie dough during prolonged storage at room temperature. Preferably the mold inhibitor is present in the cookie dough at about 0.07-0.12 weight percent and, more preferably, at about 0.08-0.10 weight percent. Most preferably, the mold inhibitor is potassium sorbate present at about 0.1% by weight in the dough composition. Potassium sorbate is widely known in the food industry and readily available from suppliers. Other antimycotic agents which may inhibit the growth of undesirable yeasts and/or molds in the dough composition include salts of acetic acid, salts of propionic acid, salts of lactic acid, salts of citric acid, or calcium phosphate. These agents are generally present at about 0.1 to 0.2% by weight. Too little will not provide sufficient antimycotic effect, while too much can impart an off taste to the dough product.

The above composition of the cookie dough invention provides a basic sugar cookie dough that is stable at room temperature for at least about 120 days. This basic dough can be supplemented with additional edible particulates substances, including chocolate chips, white and dark chocolate chunks, various candy bits, or oatmeal and raisins, to produce a similar complete cookie dough, shelf stable at room temperature, containing any of the additional edible particulates.

Also included in the present invention is a process for preparing the complete room temperature shelf stable cookie dough composition. A commercial mixing machine is employed to mix the ingredients in a single container. The process includes the steps of first mixing together, also termed “creaming,” the selected amounts of sugar, fluid corn syrup/sugar blend, shortening, eggs, emulsifier, flavoring, salt, and mold inhibitor to form a first creamed slurry. Next, the selected amount of flour, plus sodium carbonate in the case of oatmeal/raisin cookies, is added to and mixed with the first creamed slurry to produce a first dough mixture. Lastly, a selected amount of encapsulated sodium bicarbonate is added and mixed with the first dough mixture to produce a final dough product with a water activity less than about 0.75 and a pH greater than about 7.0.

Additional edible particulates, including chocolate chips, white and dark chocolate chunks, various candy bits, or oatmeal and raisins, are mixed into the final dough product to produce a cookie dough having the edible particulates distributed therein. The final dough product is transferred to a suitable container that can be sealed for storage of the dough product at room temperature for at least about 120 days without separation of components and without microbial growth.

The preferred complete dough compositions disclosed in the following examples were formulated to better illustrate the scope of the present invention. In each of the examples below, the fluid corn syrup/sugar blend to sucrose ratio was 1.0:2.5 by weight, the solid to liquid shortening ratio was 3.0:1.0 by weight, and the emulsifiers lactylate hydrate and lecithin ratio was 3.0:1.0 by weight. The eggs were a preserved whole egg fluid material containing about 50 wt-% sugar, with a whole egg to sugar ratio of 1.0:1.0.

### EXAMPLE 1

A dough composition having 20.60% sucrose, 8.22% fluid corn syrup/sugar blend, 14.57% shortening, 36.47% flour, 13.61% preserved eggs, 3.21% emulsifier, 1.53% flavoring, 1.17% encapsulated sodium bicarbonate, 0.51% salt, and 0.10% mold inhibitor, all measured by weight, were combined according to the method outlined above. The A_{w} value for the final dough product composition was 0.76, and the pH value was 8.17.

### EXAMPLE 2

A dough composition having 18.34% sucrose, 7.32% fluid corn syrup/sugar blend, 12.97% shortening, 32.47% flour, 12.12% preserved eggs, 2.85% emulsifier, 1.36% flavoring, 1.04% encapsulated sodium bicarbonate, 0.46% salt, 0.09% mold inhibitor, and 10.98% chocolate chips, all measured by weight, were combined according to the method outlined above. The A_{w} value for the final dough product composition was 0.757 and the pH value was 8.17.

### EXAMPLE 3

A dough composition having 15.44% sucrose, 6.16% fluid corn syrup/sugar blend, 10.90% shortening, 24.64% flour, 10.20% preserved eggs, 2.40% emulsifier, 1.10% flavoring, 1.16% baking powder, 0.78% encapsulated sodium bicarbonate, 0.38% salt, 0.08% mold inhibitor, 7.51% rolled oats, and 19.25% raisins, all measured by weight, were combined according to the method outlined above. The baking powder was mixed with the flour and the resulting mixture was added and mixed with the first creamed slurry. The A_{w} value for the final dough product composition was 0.719 and the pH value was 8.04.

### EXAMPLE 4

A dough composition having 17.31% sucrose, 6.90% fluid corn syrup/sugar blend, 12.05% shortening, 30.20% flour, 11.43% preserved eggs, 2.69% emulsifier, 1.28% flavoring, 0.97% encapsulated sodium bicarbonate, 0.43% salt, 0.086% mold inhibitor, 5.18% white chocolate chunks, 10.36% chocolate chunks, and 1.12% cocoa, all measured by weight, were combined according to the method outlined above. The cocoa was added with the first group of ingredients to produce the first creamed slurry. The A_{w} value for the final dough product composition was 0.754 and the pH value was 7.47.

Federal regulations at present require a food product to have an A_{w} no more that 0.85 for designating a product as “shelf stable.” Also, federal regulations require that “shelf stable” food products have a pH not to exceed 4.6. In each of the example compositions above, the A_{w} is less than about 0.75. Surprisingly, the pH for each of the example compositions is above 7.0, or slightly basic.

The pH of the example dough compositions ranges from 7.47 to 8.17. Thus, the novel dough composition of the present invention is shelf stable with a low water activity, A_{w}<0.75, and with a basic pH, greater than 7.0.

In each of the above examples, the A_{w} value is no greater than about 0.75, which indicates that each of the resulting dough compositions is resistant to microbial degradation when stored at room temperature for a period of at least about 120 days. To confirm the stability of the dough composition to microbial and mycotic degradation, microbial and mycotic assays were performed on the dough composition of Example 2 above over 120 days storage at room temperature. Samples of dough were placed in clean, sealed containers held at room temperature, with assays performed on a previously unopened sample at days 30,60,90 and 120. Samples were analyzed for the bacteria Bacillus Cereus, Enterobacteriaceae, Clostridium Perfringens, Coliforms, E. Coli, Listeria, Psychrotrophs, Salmonella, Shigella, Staphylococcus, and Yersinia, as well as a Standard Plate Count (S.P.C.), an Anaerobic Plate Count (A.P.C.), a Yeast Count and a Mold Count. The assay results are presented in Table 1 below where colony forming units/gram (CFU/G) are the units of measure. No significant bacterial, yeast or mold growth was detected over the 120 day test period.

TABLE 1

| | All | S.P.C. | | | |
|---|---|---|---|---|---|
| | Bacteria | (Est.) | A.P.C. (Est.) | Yeast | Mold |
| Day 30 | Negative | 240 | <10 CFU/G | <10 CFU/G | 90 CFU/G |
| | | CFU/G | | | |
| Day 60 | Negative | 120 | <10 CFU/G | <10 CFU/G | 25 CFU/G |
| | | CFU/G | | | |
| Day 90 | Negative | 300 | <10 CFU/G | <10 CFU/G | 190 |
| | | CFU/G | | | CFU/G |
| Day | Negative | 80 | <10 CFU/G | <10 CFU/G | 15 CFU/G |
| 120 | | CFU/G | | | |

While the invention has been particularly shown and described with reference to preferred embodiments thereof, it will be understood by those skilled in the art that various changes in form and details may be made therein without departing from the spirit and scope of the invention.

We claim:

1. A cookie dough comprising;
(a) flour;
(b) sugar, including a fluid corn syrup/sugar blend;
(c) shortening;
(d) eggs;
(e) emulsifier;
(f) leavening; and
(g) mold inhibitor, wherein the cookie dough has an A_{w} of less than about 0.75, a pH greater than 7.0, and is shelf stable at room temperature.

2. The cookie dough of claim 1 wherein the flour provides structure to the cookie dough.

3. The cookie dough of claim 1 wherein the flour comprises about 20-40 weight percent of the cookie dough.

4. The cookie dough of claim 1 wherein the flour includes bleached, enriched wheat flour.

5. The cookie dough of claim 1 wherein the flour includes barley flour.

6. The cookie dough of claim 1 wherein the flour includes bleached, enriched wheat flour and barley flour.

7. The cookie dough of claim 6 wherein the flour includes bleached, enriched wheat flour and barley flour in a ratio of about 10.0:1.0.

8. The cookie dough of claim 1 wherein the sugar, including a fluid corn syrup/sugar blend, provides the cookie dough with an A_{w} of less than about 0.75.

9. The cookie dough of claim 1 wherein the sugar, including a fluid corn syrup/sugar blend, comprises about 20-40 weight percent of the cookie dough.

10. The cookie dough of claim 1 wherein the sugar includes sucrose.

11. The cookie dough of claim 10 wherein the sucrose includes white sugar.

12. The cookie dough of claim 10 wherein the sucrose includes brown sugar.

13. The cookie dough of claim 10 wherein the sucrose includes white sugar and brown sugar.

14. The cookie dough of claim 13 wherein the sucrose includes white sugar and brown sugar in a ratio of about 1.7:10.

15. The cookie dough of claim 1 wherein the sugar includes sucrose mixed with the eggs as a preservative thereof.

16. The cookie dough of claim 1 wherein the sugar includes a fluid blend of corn syrup, fructose, and liquid sucrose.

17. The cookie dough of claim 1 wherein the sugar includes a fluid blend of about 63% corn syrup, about 8% fructose, about 28% liquid sucrose, and about 1% imitation vanillin.

18. The cookie dough of claim 1 wherein the sugar includes sucrose and a fluid blend of corn syrup, fructose, and liquid sucrose.

19. The cookie dough of claim 18 wherein the sugar includes sucrose and a fluid blend of corn syrup, fructose, and liquid sucrose in a ratio of about 2.5:1.0.

20. The cookie dough of claim 1 wherein the sugar includes sucrose and sucrose mixed with the eggs as a preservative thereof.

21. The cookie dough of claim 1 wherein the sugar includes sucrose, a fluid blend of corn syrup, fructose, and liquid sucrose and sucrose mixed with the eggs as a preservative thereof.

22. The cookie dough of claim 1 wherein the shortening enhances organoleptic properties of the cookie dough.

23. The cookie dough of claim 1 wherein the shortening comprises about 10-20 weight percent of the cookie dough.

24. The cookie dough of claim 1 wherein the shortening includes solid shortening.

25. The cookie dough of claim 24 wherein the solid shortening includes hydrogenated vegetable oil.

26. The cookie dough of claim 25 wherein the solid shortening includes hydrogenated soybean oil and cotton seed oil mixture.

27. The cookie dough of claim 1 wherein the shortening includes liquid shortening.

28. The cookie dough of claim 27 wherein the liquid shortening includes vegetable oil.

29. The cookie dough of claim 28 wherein the liquid shortening includes soybean oil.

30. The cookie dough of claim 1 wherein the shortening includes solid shortening and liquid shortening.

31. The cookie dough of claim 30 wherein the shortening includes solid shortening and liquid shortening in a ratio of about 3.0:1.0

32. The cookie dough of claim 30 wherein the solid shortening includes hydrogenated vegetable oil.

33. The cookie dough of claim 32 wherein the solid shortening includes hydrogenated soybean oil and cotton seed oil mixture.

34. The cookie dough of claim 30 wherein the liquid shortening includes vegetable oil.

35. The cookie dough of claim 34 wherein the liquid shortening includes soybean oil.

36. The cookie dough of claim 30 wherein the shortening includes hydrogenated vegetable oil and vegetable oil.

37. The cookie dough of claim 36 wherein the shortening includes hydrogenated vegetable oil and soybean oil.

38. The cookie dough of claim 37 wherein the shortening includes hydrogenated soybean oil and cotton seed oil mixture and soybean oil.

39. The cookie dough of claim 1 wherein the eggs provide body to the cookie dough.

40. The cookie dough of claim 1 wherein the eggs include a preserved egg material comprising about 8-15 weight percent of the cookie dough.

41. The cookie dough of claim 1 wherein the eggs include a preserved egg material comprising whole eggs and sugar in a ratio of about 1.0:1.0.

42. The cookie dough of claim 1 wherein the emulsifier prevents component separation of the cookie dough.

43. The cookie dough of claim 1 wherein the emulsifier comprises about 2-4 weight percent of the cookie dough.

44. The cookie dough of claim 1 wherein the emulsifier includes lactylate hydrate.

45. The cookie dough of claim 1 wherein the emulsifier includes lecithin.

46. The cookie dough of claim 1 wherein the emulsifier includes lactylate hydrate and lecithin.

47. The cookie dough of claim 46 wherein the emulsifier includes lactylate hydrate and lecithin in a ratio of about 3.0:1.0.

48. The cookie dough of claim 1 wherein the leavening provides a predetermined density to a baked cookie dough.

49. The cookie dough of claim 1 wherein the leavening comprises about 0.5-1.5 weight percent of the cookie dough.

50. The cookie dough of claim 1 wherein the leavening includes sodium bicarbonate.

51. The cookie dough of claim 50 wherein the sodium bicarbonate is encapsulated.

52. The cookie dough of claim 1 wherein the mold inhibitor comprises about 0.7-1.2 weight percent of the cookie dough.

53. The cookie dough of claim 1 wherein the mold inhibitor includes a salt of sorbic acid.

54. The cookie dough of claim 53 wherein the salt of sorbic acid is potassium sorbate.

55. The cookie dough of claim 1 comprising;
(a) about 20-40 weight percent flour;
(b) about 20-40 weight percent sugar, including a fluid corn syrup/sugar blend;
(c) about 10-20 weight percent shortening;
(d) about 8-15 weight percent preserved eggs;
(e) about 2-4 weight percent emulsifier;
(f) about 0.5-1.5 weight percent leavening; and
(g) about 0.07-0.12 weight percent mold inhibitor.

56. The cookie dough of claim 1 comprising;
(a) about 30-37 weight percent flour;
(b) about 25-36 weight percent sugar, including a fluid corn syrup/sugar blend;
(c) about 10-15 weight percent shortening;
(d) about 10-14 weight percent preserved eggs;
(e) about 2-4 weight percent emulsifier;
(f) about 0.9-1.2 weight percent leavening; and
(g) about 0.08-0.10 weight percent mold inhibitor.

57. The cookie dough of claim 1, further comprising salt to improve taste of the cookie dough.

58. The cookie dough of claim 1, further including salt comprising about 0.3-0.6 weight percent of the cookie dough.

59. The cookie dough of claim 1, further comprising flavoring to improve taste of the cookie dough.

60. The cookie dough of claim 1, further including flavoring comprising about 1.0-1.7 weight percent of the cookie dough.

61. The cookie dough of claim 59 wherein the flavoring includes vanillin flavoring.

62. The cookie dough of claim 59 wherein the flavoring includes a butter, vanillin, and lemon flavoring.

63. The cookie dough of claim 59 wherein the flavoring includes vanillin flavoring and a butter, vanillin, and lemon flavoring.

64. The cookie dough of claim 63 wherein the flavoring includes vanillin flavoring and a butter, vanillin, and lemon flavoring in a ratio of about 2.0:1.0.

65. The cookie dough of claim 1, further comprising edible particulates.

66. The cookie dough of claim 65, wherein the edible particulates comprise about 10-30 weight percent of the cookie dough.

67. The cookie dough of claim 65 wherein the edible particulates include chocolate chips.

68. The cookie dough of claim 65 wherein the edible particulates include white chocolate chunks and dark chocolate chunks.

69. The cookie dough of claim 65 wherein the edible particulates include candy bits.

70. The cookie dough of claim 65 wherein the edible particulates include cocoa.

71. The cookie dough of claim 65 wherein the edible particulates include raisins.

72. The cookie dough of claim 65 wherein the edible particulates include oatmeal.

73. A complete cookie dough, shelf stable at room temperature, comprising;
(a) a structure providing amount of flour;
(b) a source of sugar in an amount of about 20 to 40 weight percent, including a fluid corn syrup/sugar blend;
(c) an amount of shortening effective to enhance the organoleptic properties of the cookie dough;
(d) an amount of eggs to provide body to the cookie dough;
(e) an effective amount of emulsifier preventing component separation in the cookie dough;
(f) an effective amount of an encapsulated leavening system to provide a predetermined density to a baked cookie dough; and
(g) an effective amount of a mold inhibiting agent to prevent mold growth in the cookie dough, wherein the cookie dough has an A_{w} of less than about 0.75, a pH greater than about 7.0, and is shelf stable at room temperature.

74. The cookie dough of claim 73 wherein the flour comprises about 20-40 weight percent of the cookie dough.

75. The cookie dough of claim 73 wherein the flour includes bleached, enriched wheat flour and barley flour.

76. The cookie dough of claim 75 wherein the flour includes bleached, enriched wheat flour and barley flour in a ratio of about 10.0:1.0.

77. The cookie dough of claim 73 wherein the sugar includes sucrose.

78. The cookie dough of claim 77 wherein the sucrose includes white sugar and brown sugar.

79. The cookie dough of claim 78 wherein the sucrose includes white sugar and brown sugar in a ratio of about 1.7-1.0.

80. The cookie dough of claim 73 wherein the sugar includes sucrose mixed with the eggs as a preservative thereof.

81. The cookie dough of claim 73 wherein the sugar includes a fluid blend of corn syrup, fructose, and liquid sucrose.

82. The cookie dough of claim 73 wherein the sugar includes a fluid blend of about 63% corn syrup, about 8% fructose, about 28% liquid sucrose and about 1% imitation vanillin.

83. The cookie dough of claim 73 wherein the sugar includes sucrose and a fluid blend of corn syrup, fructose, and liquid sucrose.

84. The cookie dough of claim 83 wherein the sugar includes sucrose and a fluid blend of corn syrup, fructose, and liquid sucrose in a ratio of about 2.5:1.0.

85. The cookie dough of claim 73 wherein the sugar includes sucrose and sucrose mixed with the eggs as a preservative thereof.

86. The cookie dough of claim 73 wherein the sugar includes sucrose, a fluid blend of corn syrup, fructose, and liquid sucrose and sucrose mixed with the eggs as a preservative thereof.

87. The cookie dough of claim 73 wherein the shortening comprises about 10-20 weight percent of the cookie dough.

88. The cookie dough of claim 73 wherein the shortening includes solid shortening.

89. The cookie dough of claim 88 wherein the solid shortening includes hydrogenated soybean oil and cotton seed oil mixture.

90. The cookie dough of claim 73 wherein the shortening includes liquid shortening.

91. The cookie dough of claim 90 wherein the liquid shortening includes soybean oil.

92. The cookie dough of claim 73 wherein the shortening includes solid shortening and liquid shortening.

93. The cookie dough of claim 92 wherein the shortening includes solid shortening and liquid shortening in a ratio of about 3.0:1.0

94. The cookie dough of claim 92 wherein the solid shortening includes hydrogenated soybean oil and cotton seed oil mixture.

95. The cookie dough of claim 92 wherein the liquid shortening includes soybean oil.

96. The cookie dough of claim 92 wherein the shortening includes hydrogenated soybean oil and cotton seed oil mixture and soybean oil.

97. The cookie dough of claim 73 wherein the eggs include a preserved egg material comprising about 8-15 weight percent of the cookie dough.

98. The cookie dough of claim 73 wherein the eggs include a preserved egg material comprising whole eggs and sugar in a ratio of about 1.0:1.0.

99. The cookie dough of claim 73 wherein the emulsifier comprises about 2-4 weight percent of the cookie dough.

100. The cookie dough of claim 73 wherein the emulsifier includes lactylate hydrate.

101. The cookie dough of claim 73 wherein the emulsifier includes lecithin.

102. The cookie dough of claim 73 wherein the emulsifier includes lactylate hydrate and lecithin.

103. The cookie dough of claim 102 wherein the emulsifier includes lactylate hydrate and lecithin in a ratio of about 3.0:1.0.

104. The cookie dough of claim 73 wherein the leavening comprises about 0.5-1.5 weight percent of the cookie dough.

105. The cookie dough of claim 73 wherein the leavening includes sodium bicarbonate.

106. The cookie dough of claim 105 wherein the sodium bicarbonate is encapsulated.

107. The cookie dough of claim 73 wherein the mold inhibitor comprises about 0.07-0.12 weight percent of the cookie dough.

108. The cookie dough of claim 73 wherein the mold inhibitor includes a salt of sorbic acid.

109. The cookie dough of claim 108 wherein the salt of sorbic acid is potassium sorbate.

110. The cookie dough of claim 73 comprising;
(a) about 20-40 weight percent flour;
(b) about 20-40 weight percent sugar, including a fluid corn syrup/sugar blend;
(c) about 10-20 weight percent shortening;
(d) about 8-15 weight percent preserved eggs;
(e) about 2-4 weight percent emulsifier;
(f) about 0.5-1.5 weight percent leavening; and
(g) about 0.07-0.12 weight percent mold inhibitor.

111. The cookie dough of claim 73 comprising;
(a) about 30-37 weight percent flour;
(b) about 25-36 weight percent sugar, including a fluid corn syrup/sugar blend;
(c) about 10-15 weight percent shortening;
(d) about 10-14 weight percent preserved eggs;
(e) about 2-4 weight percent emulsifier;
(f) about 0.9-1.2 weight percent leavening; and
(g) about 0.08-0.10 weight percent mold inhibitor.

112. The cookie dough of claim 73, further including salt comprising about 0.3-0.6 weight percent of the cookie dough to improve taste thereof.

113. The cookie dough of claim 73, further including flavoring comprising about 1.0-1.7 weight percent of the cookie dough to improve taste thereof.

114. The cookie dough of claim 113 wherein the flavoring includes vanillin flavoring.

115. The cookie dough of claim 113 wherein the flavoring includes a butter, vanillin, and lemon flavoring.

116. The cookie dough of claim 113 wherein the flavoring includes vanillin flavoring and a butter, vanillin, and lemon flavoring.

117. The cookie dough of claim 116 wherein the flavoring includes vanillin flavoring and a butter, vanillin, lemon flavoring in a ratio of about 2.0:1.0.

118. The cookie dough of claim 73, further including edible particulates comprising about 10-30 weight percent of the cookie dough.

119. The cookie dough of claim 118 wherein the edible particulates includes chocolate chips.

120. The cookie dough of claim 118 wherein the edible particulates includes white chocolate chunks and dark chocolate chunks.

121. The cookie dough of claim 118 wherein the edible particulates includes candy bits.

122. The cookie dough of claim 118 wherein the edible particulates includes cocoa.

123. The cookie dough of claim 118 wherein the edible particulates includes raisins.

124. The cookie dough of claim 118 wherein the edible particulates includes oatmeal.

125. A complete cookie dough, shelf stable at room temperature, comprising;
(a) structure providing flour of about 30-37 weight percent;
(b) sugar, including a fluid corn syrup/sugar blend, the sugar of about 25 to 36 weight percent;
(c) shortening of about 10-15 weight percent, effective to enhance the organoleptic properties of the cookie dough;
(d) preserved eggs of about 10-14 weight percent, providing body to the cookie dough;
(e) emulsifier of about 2-4 weight percent, preventing dough component separation;
(f) an encapsulated leavening system of about 0.9-1.2 weight percent, providing a predetermined density to a baked cookie dough; and
(g) a mold inhibiting agent of about 0.08-0.10 weight percent, preventing mold growth in the cookie dough, wherein the cookie dough has an A_{w} of less than about 0.75, a pH greater than about 7.0, and is shelf stable at room temperature.

126. The complete cookie dough of claim 125, further including salt comprising about 0.3-0.6 weight percent of the cookie dough.

127. The complete cookie dough of claim 125, further including flavoring comprising about 1.0-1.7 weight percent of the cookie dough.

128. The complete cookie dough of claim 125, further including edible particulates comprising about 10-30 weight percent of the cookie dough.

129. A method for preparing a cookie dough, comprising the steps of;
(a) mixing sugar, a fluid corn syrup/sugar blend, shortening, eggs, emulsifier, flavoring, salt and mold inhibitor to form a creamed slurry;
(b) mixing flour with the creamed slurry to produce a first dough mixture; and
(c) mixing leavening with the first dough mixture to produce a final cookie dough product with an A_{w} of less than about 0.75, a pH greater than 7.0, the final cookie dough product being shelf stable at room temperature.

130. The method of claim 129, further comprising the step of;
mixing edible particulates with the final cookie dough product to form an edible particulates containing final cookie dough product.

131. The method of claim 130 wherein the edible particulates include chocolate chips.

132. The method of claim 130 wherein the edible particulates include dark chocolate chunks, white chocolate chunks and cocoa.

133. The method of claim 130 wherein sodium carbonate is included in mixing step (a) to form a creamed slurry, and the edible particulates include rolled oats and raisins.

134. The method of claim 129 wherein,
(a) flour comprises about 20-40 weight percent of the final cookie dough product;
(b) sugar, including a fluid corn syrup/sugar blend, comprises about 20-40 weight percent of the final cookie dough product;
(c) shortening comprises about 10-20 weight percent of the final cookie dough product;
(d) preserved eggs comprises about 8-15 weight percent of the final cookie dough product;
(e) emulsifier comprises about 2-4 weight percent of the final cookie dough product;
(f) leavening comprises about 0.5-1.5 weight percent of the final cookie dough product;
(g) flavoring comprises about 1.0-1.7 weight percent of the final cookie dough product;
(h) salt comprises about 0.3-0.6 weight percent of the final cookie dough product; and
(i) mold inhibitor comprises about 0.07-0.12 weight percent of the final cookie dough product.

135. The method of claim 130 wherein edible particulates comprise about 10-30 weight percent of the final cookie dough product.

136. The method of claim 129 wherein,
(a) flour comprises about 30-37 weight percent of the final cookie dough product;
(b) sugar, including a fluid corn syrup/sugar blend, comprises about 25-36 weight percent of the final cookie dough product;
(c) shortening comprises about 10-15 weight percent of the final cookie dough product;
(d) preserved eggs comprises about 10-14 weight percent of the final cookie dough product;
(e) emulsifier comprises about 2-4 weight percent of the final cookie dough product;
(f) leavening comprises about 0.9-1.2 weight percent of the final cookie dough product;
(g) flavoring comprises about 1.0-1.7 weight percent of the final cookie dough product;
(h) salt comprises about 0.3-0.6 weight percent of the final cookie dough product; and
(i) mold inhibitor comprises about 0.08-0.10 weight percent of the final cookie dough product.

137. A method for preparing a cookie dough comprising the steps of;
(a) mixing together selected amounts of sugar, fluid corn syrup/sugar blend, shortening, eggs, emulsifier, flavoring, salt and mold inhibitor to form a creamed slurry;
(b) mixing a selected amount of flour with the creamed slurry to produce a first dough mixture; and
(c) mixing a selected amount of leavening with the first dough mixture to produce a final cookie dough product with an A_{w} of less than about 0.75, a pH greater than 7.0, the final cookie dough product shelf stable at room temperature.

138. The method of claim 137, further comprising the step of;
mixing a selected amount of edible particulates with the final cookie dough product to form an edible particulate containing final cookie dough product.

139. The method of claim 138 wherein the edible particulates include chocolate chips.

140. The method of claim 138 wherein the edible particulates include dark chocolate chunks, white chocolate chunks and cocoa.

141. The method of claim 138 wherein sodium carbonate is included in mixing step (a) to form a creamed slurry, and the edible particulates include rolled oats and raisins.

142. The method of claim 137 wherein the selected amount of
(a) flour comprises about 30-37 weight percent of the final cookie dough product;
(b) sugar, including a fluid corn syrup/sugar blend, comprises about 25-36 weight percent of the final cookie dough product;
(c) shortening comprises about 10-15 weight percent of the final cookie dough product;
(d) preserved eggs comprises about 10-14 weight percent of the final cookie dough product;
(e) emulsifier comprises about 2-4 weight percent of the final cookie dough product;
(f) leavening comprises about 0.9-1.2 weight percent of the final cookie dough product;
(g) flavoring comprises about 1.0-1.7 weight percent of the final cookie dough product;
(h) salt comprises about 0.3-0.6 weight percent of the final cookie dough product; and
(i) mold inhibitor comprises about 0.08-0.10 weight percent of the final cookie dough product.

143. The method of claim 138 wherein the selected amount of edible particulates comprise about 10-30 weight percent of the edible particulate containing final cookie dough product.
